(19) United States
(12) Patent Application Publication
(10) Pub. No.: US 2014/0146051 A1
(43) Pub. Date: May 29, 2014

(54) Visualization of Question and Related Informational Item Data

(71) Applicant: CISCO TECHNOLOGY, INC., San Jose, CA (US)

(72) Inventors: Jay Kemper Johnston, Raleigh, NC (US); David C. White, JR., Durham, NC (US); Magnus Mortensen, Cary, NC (US); Wen Zhang, Cary, NC (US); Christopher Blayne Dreier, Austin, TX (US)

(73) Assignee: CISCO TECHNOLOGY, INC., San Jose, CA (US)

(21) Appl. No.: 13/688,634

(22) Filed: Nov. 29, 2012

(51) Int. Cl. G06T 11/20

(52) U.S. Cl. CPC G06T 11/206
USPC 345/440

(57) ABSTRACT

Data indicating a plurality of informational items is received at a processor. The data further comprises at least one useful informational item. Also received at the processor is data indicating a plurality of questions, including at least one unanswered question. The processor analyzes the data to determine a number of unanswered questions and a number of useful informational items. The processor generates a visualization comparing the number useful informational items to the number of unanswered questions. The visualization is displayed on a display.

### TECHNICAL FIELD

The present disclosure relates to the analysis and visualization of data.

### BACKGROUND

In order to provide answers to customer inquiries in an efficient manner, organizations employ knowledge bases to provide self-help to customers. Additionally, organizations employ internal knowledge bases to assist their representatives in answering customer questions. Depending on the size of the customer base, scope of the organization's products, and the size of the organization, the necessary knowledge bases may grow to be very large in size and scope.

Depending on the size of an organization, there may be limited resources available to generate informational items to include in a knowledge base. For example, an organization's subject matter experts may be extremely busy developing new products or enhancing current products, leaving little time to populate a knowledge base. Understanding what specific content is most needed in a knowledge base allows an organization to prioritize their limited resources used to create reusable knowledge.

### BRIEF DESCRIPTION OF THE DRAWINGS

FIG. 1 depicts an example data set comprising question and informational item data.

FIG. 2 depicts a second example data set comprising question and information item data.

FIG. 3 depicts an example visualization of question data and informational item data indicating the usefulness of the informational item data as well as gaps in the informational item data.

FIG. 4 depicts an example visualization of detailed informational item data.

FIG. 5 depicts an example visualization of detailed question data.

FIG. 6 depicts a three-dimensional visualization of information item data and question data.

FIG. 7 is a flowchart illustrating a method of displaying question and informational item data.

FIG. 8 is a block diagram illustrating an example apparatus for displaying visualizations of question data and informational item data.

### DESCRIPTION OF EXAMPLE EMBODIMENTS

Overview

Data indicating a plurality of informational items is received at a processor. The data further comprises at least one useful informational item. Also received at the processor is data indicating a plurality of questions, including at least one unanswered question. The processor analyzes the data to determine a number of unanswered questions and a number of useful informational items. The processor generates a visualization comparing the number useful informational items to the number of unanswered questions. The visualization is displayed on a display.

### Example Embodiments

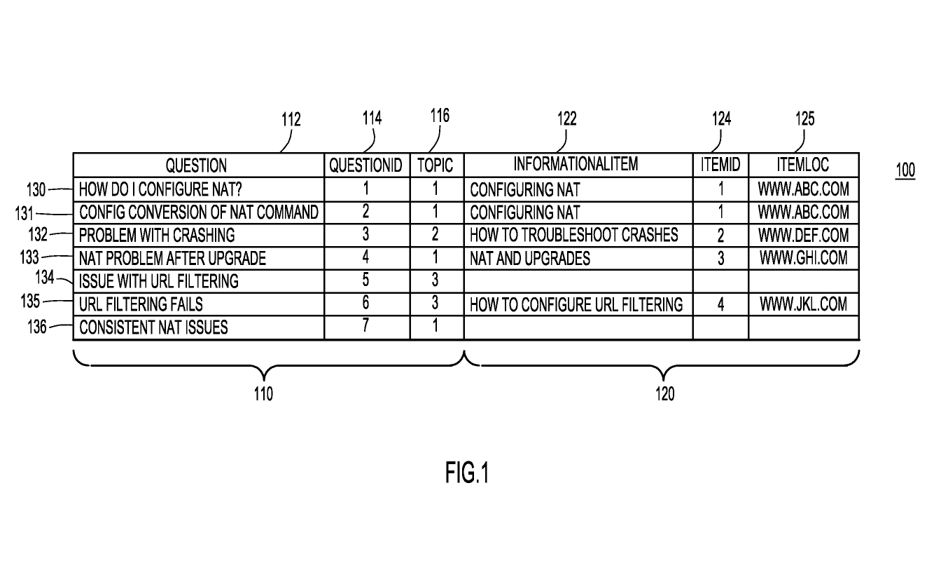

Depicted in FIG. 1 is a data set embodied in data table 100. Table 100 includes question data 110 which may be indicative of a questions asked on an internet message board, or other types of questions, such as questions received at a help desk call center. If the message board or call center is used to provide technical assistance to customers it may be beneficial to track how the question is answered or addressed. It may also be beneficial to determine which questions are not being adequately addressed and why. For example, an organization may wish to quickly determine the subject matter areas in which users are asking questions, the volume of questions which are being asked, and also any gaps in the resources or knowledge used to address the questions. Accordingly, techniques are provided herein for visualizing these knowledge gaps. An example data set for these techniques is depicted in table 100.

Turning to the contents of table 100, question data 110 is maintained in columns 112, 114 and 116, and informational item data 120 is maintained in columns 122, 124 and 125. Specifically, column 112 contains an indication of the content of a question, such as the full question, or an abbreviation thereof. Alternatively, if the question was originally posted to an internet message board, column 112 may be populated with the title of the posting. Column 114 includes a unique identifier for the question, while column 116 provides an identifier of the topic to which the question relates. For example, the entries contained in rows 130, 131 and 133 are all directed to network address translation, or NAT. Accordingly, the data items in rows 130, 131 and 133 all have the same topic identifier of “1.” While data table 100 only includes a numerical indication of the topic, table 100 may be linked to another data table to retrieve the topic name. Other example implementations may store the topic name with the question data. Though not depicted, additional question data may include subtopic information, or information to identify the source of the question.

According to the example of FIG. 1, whether or not a question has been answered is determined based upon whether or not the question has been linked to an informational item. Accordingly, table 100 also includes informational item data 120. Though, according to other examples, other methods of indicating whether or not a question has been answered may be used. For example, a simple flag (e.g. a field populated with a “1” or a “0”) may be used to indicate whether or not a question has been answered. In other words, determining whether a question has been answered does not necessarily have to be determined through a link to an informational item.

Informational item data 120 includes an informational item name 122 as well as a unique identifier 124. Informational item data 120 may also include an ItemLoc value 125 indicating a location for where the informational item may be found. While FIG. 1 only includes URLs, other information, such as an internal directory address, may be used to indicate a location of the informational item. Of course, other examples may include additional fields.

By including information item data 120 in the same data entry as question data 110, a link between the question and the informational item is created. For example, because the “Configuring NAT” informational item is included in row 130 along with the “How do I configure NAT” question, this is an indication that the “Configuring NAT” informational item has been linked to the “How do I configure NAT” question. Remaining with the message board example, the “How do I configure NAT” item may represent a question posed on the message board. A NAT subject matter expert may come across the “How do I configure NAT” question while perusing the message board. Knowing where to find the answer to the question, the subject matter expert posts a response which includes a link to the “Configuring NAT” informational item. This link created by the subject matter expert may be automatically created by the message board, or an administrator may record the link as part of their administrative duties.

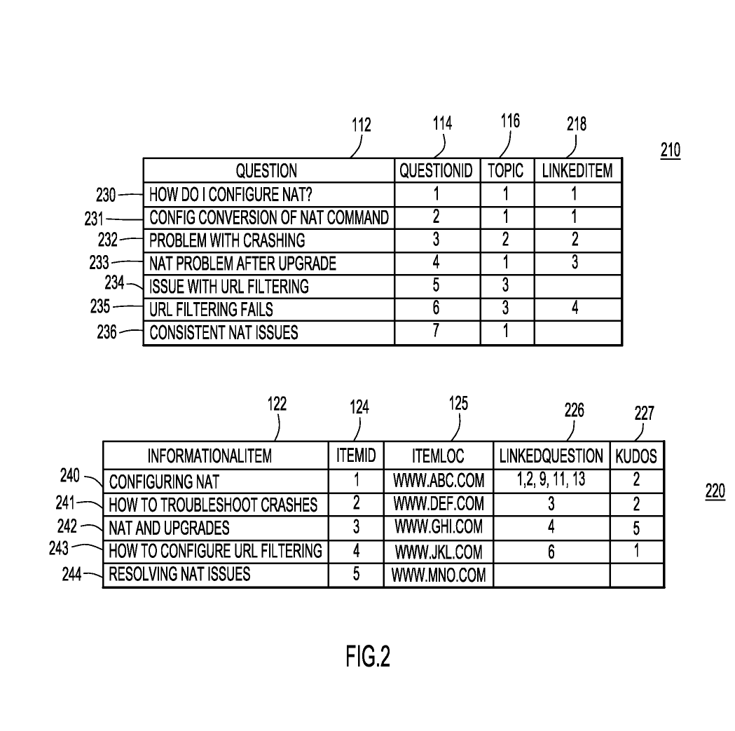

With reference now made to FIG. 2, depicted therein are data tables 210 and 220. As depicted, the question data is maintained in table 210 while informational item data is maintained in table 220. As in FIG. 1, column 112 contains an indication of the content of a question, column 114 includes a unique identifier for the question, and column 116 provides an identifier of the topic to which the question relates. As with table 100 of FIG. 2, table 210 utilizes a LinkedItem column 218 to determine whether or not a question has been answered. Specifically, column 218 is used to show that a link has been made between a question and an informational item. For example, the question contained in row 230 of table 210 includes a value of “1” in its entry in LinkedItem column 218. Accordingly, the question in row 230 of table 210 is linked to the informational item entry in row 240 of table 220 because the LinkedItem entry for row 230 matches the entry in the ItemId column 124 for row 240. As with table 100 of FIG. 1, table 210 may also use other methods, such as a flag, to determine whether or not a question has been answered.

Also contained in table 220 are columns analogous to those presented in table 100 of FIG. 1, such as InformationalItem column 122 which provides a name for the informational item, and an ItemLoc value 125 indicating a location for where the informational item may be found. The additional columns not found in table 100 of FIG. 1, LinkedQuestions column 226 and Kudos column 227, provide additional information concerning each informational item. LinkedQuestion column 226 contains an indication of the questions to which the informational item has been linked. While the linking information is also contained in column 218 of table 210, by consolidating the linking information for each informational item in table 220, this information can be retrieved without also referencing table 210. Kudos column 227 is an indication that the informational item was not only linked to a question, but that a user indicated that the informational item was actually helpful, or answered the question. For example, internet message boards and social networking sites often have functionalities that allow a user to mark an item as having been “liked,” “useful,” “helpful,” or in the present context, give an object praise in the form of “kudos.” The Kudos column 227 provides a count of how many times an informational item has received these types of indications.

Data fields like columns 226 and 227 may be considered indications of “usefulness.” As used herein, an indication of usefulness is a property of an informational item that indicates that the item is useful in resolving questions and/or issues directed to the subject matter contained in the informational item beyond the simple existence of the informational item. For example, the “Resolving NAT Issues” informational item located at row 244, while known to exist in the example data, would not be considered as having any indications of usefulness. On the other hand, each of the other entries in table 220 have at least two types of indications of usefulness, as the entries in rows 240-243 have data in both the LinkedQuestion column 226 and the Kudos column 227. Other indications of usefulness may include the number of times the question or informational item has been “viewed” or “read”, or the number of times the question or informational item has been referred to in another document.

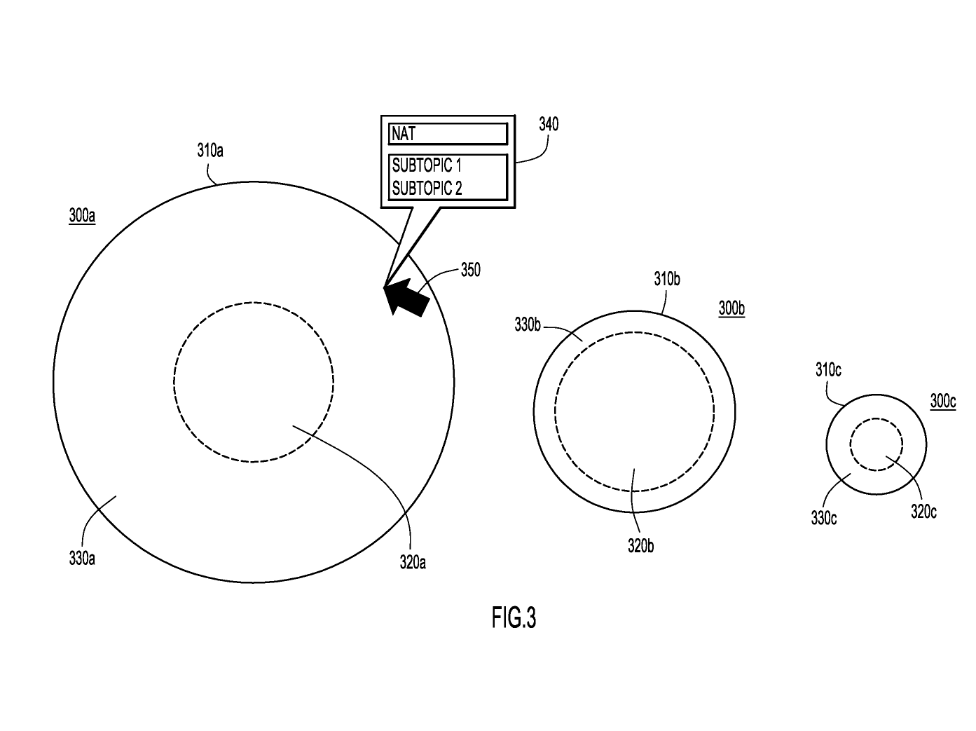

Turning now to FIG. 3, depicted therein are three visual representations 300a-c created through analyzing data, such as the data depicted in FIGS. 1 and 2. Each of visual representations 300a-c comprises a total area 310a-c, an inner area 320a-c, and an area comprising the difference between the two, area 330a-c. Inner area 320a-c is determined based on the number of useful informational items for a particular topic. For example, area 320a is based upon the number of useful informational items in the NAT category, while areas 320b and 320c are based upon the number of useful informational items in the URL Filtering and Crashes categories, respectively. Annular shaped areas 330a-c are based upon the number of unanswered questions in the category. Accordingly, area 330a is determined based on the number of unanswered questions in the NAT category, area 330b is based upon the number of unanswered questions in the URL Filtering category, and area 330c is based upon the number of unanswered questions in the Crashes category.

By surrounding inner areas 320a-c, which are based on the number of useful informational items, with annular areas 330a-c, which are based on the number of unanswered questions, and comparing the relative sizes of the two areas, a determination can be made whether or not the informational items are adequately addressing the questions being asked for a particular topic. In other words, it can be determined whether or not there is a knowledge gap for a particular category of questions.

Similarly, if there are no informational items that have been indicated as being useful, or no unanswered questions, either because all questions have been answered or no questions have been asked, the absence of areas 320a-c or 330a-c may also be informative to a user. For example, if areas 330a-c are large, and comprise full circles, it can be determined that there are a large number of unanswered questions that are not addressed by any informational items. Similarly, areas 320a-c which are not surrounded by any unanswered questions may lead to further investigation to determine whether all questions have been answered, or if there are informational items unnecessarily created to address questions which are not being asked.

When linked informational items are used to determine the usefulness of an informational item and whether or not a question has been answered, visualizations 300a-c allow for an easy three-way comparison between the total number of questions related to a particular topic, the number of questions related to the particular topic that have been linked to (or answered by) at least one informational item, and the number of questions related to a particular topic which have not been linked to at least one informational item.

According to the example of FIG. 3, the total area 310a-c represents the total number of questions in a specific category. To use the categories present in the sample data of FIGS. 1 and 2, area 310a may represent the total number of questions related to NAT, area 310b may represent the total number of questions related to URL Filtering, and area 310c may represent the total number of questions related to Crashes. Area 320a may represent the number of questions related to NAT that have been linked to at least one informational item. Accordingly, the questions located in rows 230, 231 and 233 of FIG. 1b would be represented in area 320a. Similarly, area 320b may represent the number of questions related to URL Filtering that have been linked to at least one informational item, while area 320c may represent the number of questions related to Crashes that have been linked to at least one informational item. By overlapping area 320a with area 310a, area 330a is created which represents the number questions that have not been linked to any informational items, and therefore, not answered. Accordingly, the entry in row 236 of FIG. 1b would be represented in area 330a.

Through visualizations 300a-c an evaluation of gaps in a knowledge base can be quickly determined. For example, given the large area 300a relative to the area of visualizations 300b and 300c, it can be easily determined that there is a significantly greater number of questions related to NAT than there are for Crashes and URL Filtering. Furthermore, it can easily be determined that there are significant knowledge gaps in the currently available knowledge base for NAT, while significantly smaller gaps are present for the URL Filtering and Crashes topics. For example, areas 320a and 320b are the same size. Accordingly, if just these questions are considered, an administrator may come away with an erroneous view that the information available for the NAT and Crashes categories are providing similar coverage for the questions posed in their respective categories. It may also be the case that an administrator would view the total number of questions represented by areas 310b and 310c and come to the erroneous conclusion that the URL Filtering topic represented by area 310c is being better served than the Crash topic represented by area 310b due to the smaller number of URL Filtering questions. Yet, by including all three areas 310a-c, 320a-c and 330a-c, for all three topics, an accurate understanding of the relative knowledge gaps can be accurately determined.

By showing all three areas, 310a-c, 320a-c and 330a-c, an administrator can make a quick and accurate determination of the actual gaps in the knowledge base. For example, it can quickly be determined that even though the number of questions linked to an informational item is the same for the NAT and Crash categories, given the greater number of questions related to NAT, and therefore an area 330a greater than 330b, it is obvious that there are more gaps and a greater need to increase the amount of useful content in the NAT category of the knowledge base. Furthermore, even though there are a greater number of questions being directed to the Crashes category than there are questions directed to the URL Filtering category, because the relative sizes of areas 310b, 320b and 330b can be quickly and accurately compared to the relative sizes of 310c, 320c and 330c, it can be quickly and accurately determined that the Crash topic is being serviced as well if not better than the URL Filtering topic.

In other words, by visually displaying to the user both the frequency of a discussion topic (indicated by the size of areas 310a-c), as well as the usefulness of the existing content that matches that topic (indicated by the size of areas 320a-c), the user can understand what specific content is needed in the knowledge base. Specifically, visualizations such as those provided by visualization 300a-c provide a view of what technical subjects are in most need of useful content across different categories. Resources can then be re-focused to target creating content in one category over another, based on need. Additionally, by viewing visualizations 300a-c together, a view into the overall “health” of a knowledge base, and the relative “health” of the different categories can be easily ascertained.

Accordingly, visualizations 300a-c provide an easy way for organizations to understand where gaps exist in their self-help knowledge management systems. The visualizations display existing knowledge linked to customer questions/problems (showing where the existing knowledge articles meet the customer needs), and areas where customer questions have little or no associated knowledge—and thus areas where content must be developed in order to pro-actively answer those customer questions.

Furthermore, the visualizations 300a-c may provide further information through information box 340. Specifically, if the user selects a specific visualization, in this case visualization 300a, information box 340 may be displayed. The selection of visualization 300a may be accomplished by selecting visualization 300a with a predetermined number of mouse clicks, hovering over visualization 300a with cursor 350, or other methods. Once displayed, information box 340 may display detailed information for visualization 300a. For example, information box 340 may display the topic to which the questions represented by visualization 300a are directed, the number of questions related to the topic, the number of questions represented by areas 310a, 320a and 330a, the subtopics covered under the main topic, as well as other information stored about the questions represented by visualization 300a.

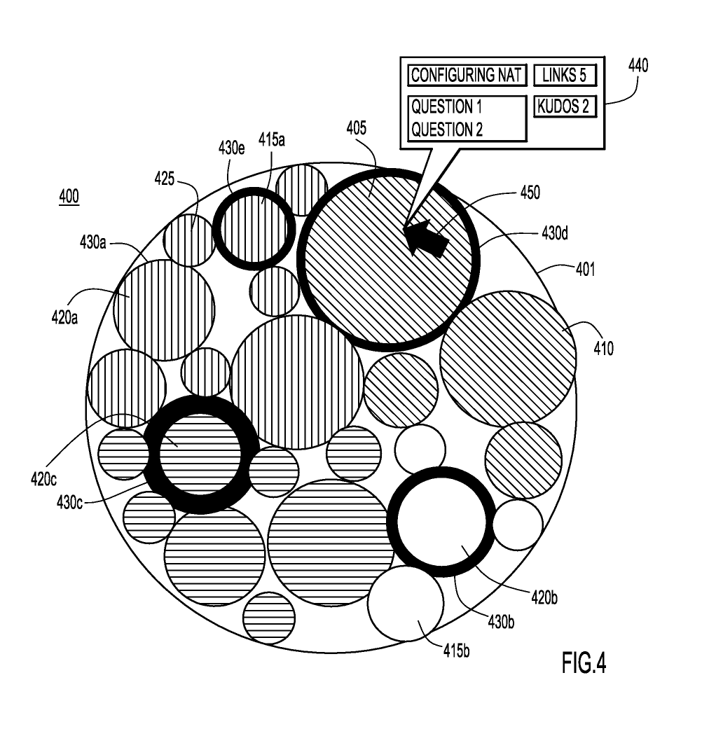

According to examples, the visualizations 300a-c are interactive, allowing users to “drill down” to view the details of the data visualized by the different areas 310a-330c. As one example, FIG. 4 depicts a visualization 400 which provides additional drill-down information for one of visualizations 300a-c from FIG. 3. Specifically, a user may select area 320a of FIG. 3. The selection may comprise single clicking, double clicking, right-clicking, or otherwise indicating a desire to drill-down into area 320a. In response, visualization 400 of FIG. 4 may be displayed. Visualization 400 comprises a total area 401 which may be shaped to correspond with area 320a. For example, the shape of area 401 may be chosen to suggest to the user that they are examining the contents of area 320a. Furthermore, when displaying visualization 400, the transition from FIG. 3 to FIG. 4 may give the impression that the user has zoomed-in on the contents of area 320a. According to other examples, visualization 400 may be displayed directly within area 320a of visualization 300a of FIG. 3. Located within area 401 is a plurality of additional visualizations 405-420 which represent the useful informational items. For example, visualizations 405-420 may represent the informational items directed to the NAT subject, and contained within a data table such as table 220 of FIG. 2.

Specifically, each of the visualizations 405-420 corresponds to a NAT informational item. Furthermore, characteristics of visualization 405-420 can be used to show additional information concerning each informational item. Take for example visualization 405 which has a significantly larger size than the other visualizations 410-420. The size or area of the visualizations 405-420 may be made in proportion to the number of times the corresponding informational item has been linked to a question. If visualization 405 corresponds to the informational item contained in row 240 of table 220 of FIG. 2, the size of visualization 405 will provide a visual indication that the informational item has been linked to 5 questions. Visualization 410, on the other hand, may represent an informational item that has been linked to three questions, visualizations 420a-c may represent informational items that have been linked to two questions, and informational items 415a-b may represent informational items that have been linked to a single question each.

Also included in visual representation 400 are smaller visualizations, such as visualization 425. These smaller visualizations may be displayed to indicate informational items that exist within a knowledge base, but that have not yet been linked to any questions. According to the present example, as these informational items have not been linked to any questions they do not contribute to the size of area 320 in FIG. 3, but are displayed in visualization 400 so that a user may be aware of their existence. By displaying these smaller visualizations, such as visualization 425, a determination can be made as to where investment has been made in knowledge creation without having received any return on the investment. This determination assists organizations in redirecting resources from theses areas to the questions which are not being answered by the current knowledge base.

Turning to visualizations 420a-c, it can be seen that these visualization share a common size, but have a different border thickness. Specifically, border 430b is thicker than border 430a, and border 430c is, in turn, thicker than border 430b. The borders as used in FIG. 4 are used to indicate additional indications of usefulness other than the number of times an informational item has been linked to a question. According to the present example, the thickness of the border represents the number of “kudos” that an informational item has received. Accordingly, it can be visually determined that the informational item represented by visualization 420c has received three kudos due to the thickness of border 430c, the informational item represented by visualization 420b has received two kudos from the thickness of border 430b, and the informational item represented by visualization 420a has received zero kudos.

Additionally, even though the size of visualizations 405 and 415a differ from those of 420a-c, it can be determined that informational items represented by these visualizations have received one kudo a piece, as the thickness of borders 430d and 430e are thicker than border 430a, but thinner than border 430b.

Furthermore, it can be determined that a visualization, such as visualization 425, has received no kudos, and is not linked to any documents. Accordingly, a determination can be made to shift resources from the topic covered by the informational item represented by visualization 425 to other areas in which there are present gaps in the knowledge base.

Of course, depending on user preferences, the thickness of the borders of visualizations 405-420 may be used to indicate the number of times the informational items represented by visualizations 405-420 have been linked to a question. Similarly, the area of the visualizations 405-420 may be used to indicate the number of “kudos” that have been received by each informational item represented by visualizations 405-420.

Additional information can also be expressed through visualizations 405-425. As depicted in FIG. 4, each of visualizations 405, 415a, 420b and 420c have had a different type of shading applied to them. The shading, or in other examples the coloring or shape, of the visualizations may be used to communicate information such as a subtopic for each visualization. According to other examples, the color may be used to express additional indications of usefulness. According to one specific example, a visualization that is colored green may be an indication that the informational item associated with the visualization has received a large number of indications of usefulness, while a red coloring may indicate that the informational item has received fewer indications of usefulness.

Furthermore, the visualizations 405-425 may provide further information through information box 440. Specifically, if the user selects a specific visualization, in this case visualization 405, information box 440 may be displayed. The selection of visualization 405 may be accomplished by selecting visualization 405 with a predetermined number of mouse clicks, hovering over visualization 405 with cursor 450, or other methods. Once displayed, information box 440 may display detailed information for the informational item associated with visualization 405. For example, information box 440 may display the title of the informational item, the number of questions to which the informational item has been linked, the title and/or text of the questions to which the informational items has been linked, the number of “kudos” the informational has received, and other information, such as additional indications of usefulness and additional subtopics to which the informational item is directed.

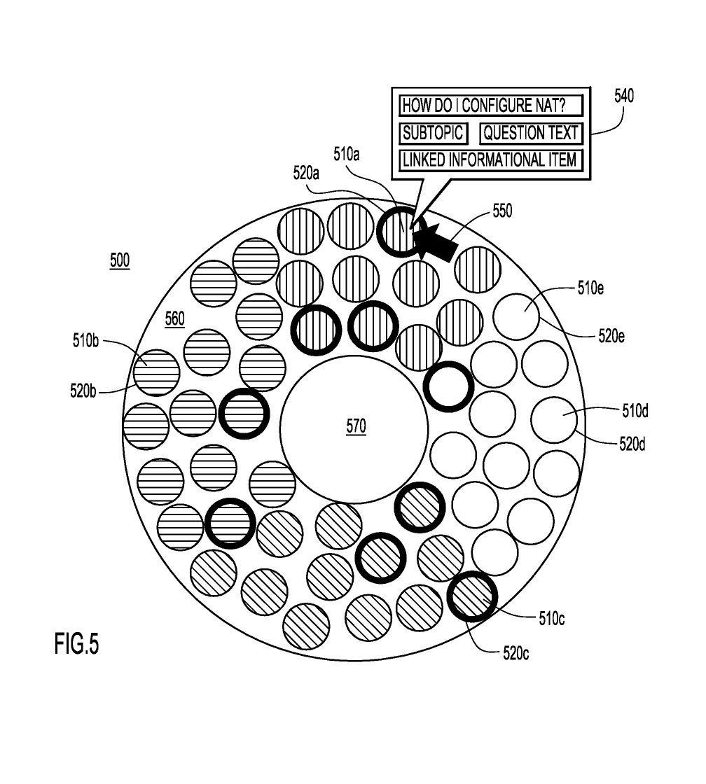

Turning now to FIG. 5, depicted therein is a visualization that may be displayed if one of areas 310a-c or 330a-c are selected. Specifically, a user may select area 330a of FIG. 3. The selection may comprise single clicking, double clicking, right-clicking, or otherwise indicating a desire to drill-down into area 330a. In response, visualization 500 of FIG. 5 may be displayed. Visualization 500 comprises a number of smaller visualizations 510a-e, each of which represents a question, such as the questions contained in table 210 of FIG. 2.

According to user preferences, visualization 500 may contain visualizations only for questions that have not been answered, such as through a link an informational item, or as depicted in FIG. 5, visualizations for both answered and unanswered questions. In FIG. 5, the answered (or linked) questions are distinguished from the unanswered (or unlinked) questions through the use of a thicker border. Accordingly, visualizations 510a and 510c which represent linked questions have borders 520a and 520c which are thicker than the borders 520b and 520d of visualization 510b and 510d which represent unlinked questions. Visualizations representing linked questions may also be distinguished from visualizations representing unlinked questions through, for example, the use of differently shaped visualizations or differently colored visualizations.

In FIG. 5, the shading or coloring of the visualizations is indicative of a subtopic of the question. For example, each of visualizations 510a-d is directed to a different subtopic indicated by their different shadings, while visualizations 510d and 510e are directed to the same subtopic because they share the same shading. According to other examples, the subtopic associated with a visualization may be indicated through other properties of the visualizations, such as a shape of the visualization.

In visualization 500, the visualizations representing answered and unanswered questions have been grouped together by subtopic. According to other examples, the visualizations may be grouped to mimic their locations in visualizations 300a-c of FIG. 3. For example, all of the visualization representing unanswered questions may be grouped in outer area 560 while all of the visualizations representing answered questions may be grouped in inner area 570.

The visualizations 510a-e may provide further information through information box 540. Specifically, if the user selects a specific visualization, in this case visualization 510a, information box 540 may be displayed. The selection of visualization 510a may be accomplished by selecting visualization 510a with a predetermined number of mouse clicks, hovering over visualization 510a with cursor 550, or other methods. Once displayed, information box 540 may display detailed information for the question associated with visualization 510a. For example, information box 540 may display the title of the question, the subtopic of the questions, the title or text of the informational item to which the question has been linked, if any, the text of the question, and other information such as additional subtopics to which the question is directed.

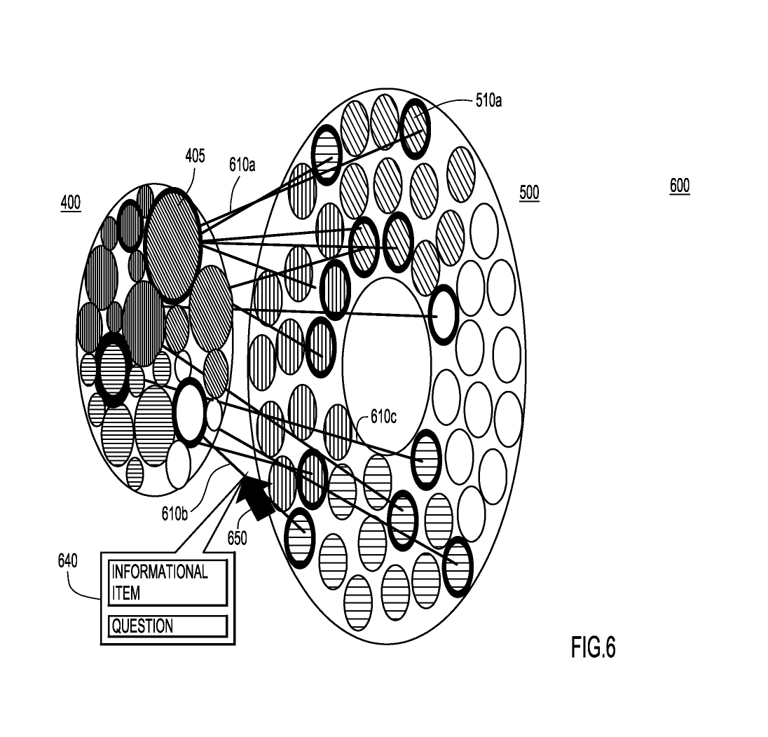

Turning to FIG. 6, depicted therein is a visualization 600 which combines visualization 400 from FIG. 4 and visualization 500 from FIG. 5 into a single three-dimensional view. Specifically, visualizations 400 and 500 contain the same information and provide the same functionality as described above in reference to FIGS. 4 and 5, respectively. Additionally, visualization 600 contains links 610 which illustrate the links between the visualizations representing informational items in visualization 400 with the visualizations representing questions in visualization 500. For example, link 610a represents the link between the informational item represented by visualization 405 and the question represented by visualization 510a. Similarly, links 610b and 610c represent additional links between the informational items represented in visualization 400 and the questions represented in visualization 500.

Each of the links 610 may be selected to show additional information about the links through information box 640. Specifically, selection of link 610b may cause information box 640 to be displayed. The selection of link 610b may be accomplished with a predetermined number of mouse clicks, hovering over link 610b with cursor 650, or other methods. Once displayed, information box 640 may display detailed information for link 610b. For example, information box 640 may display the title of the question, and the title of the informational item for link 610b, as well as other information such as the subtopic to which the question and informational item are directed.

Additionally, in order to better view the information contained in visualization 600, the view may be rotated, scaled, zoomed, or otherwise manipulated so that each visualization and link may be viewed by the user.

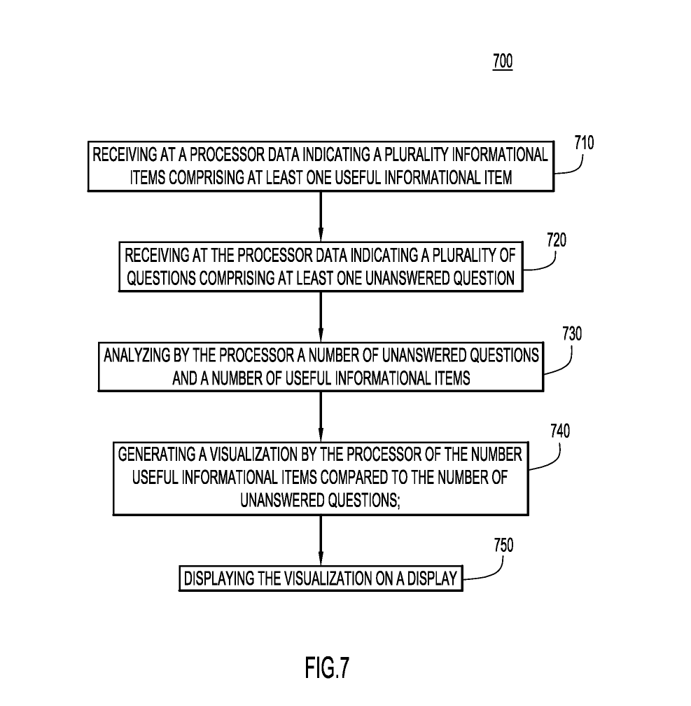

With reference now made to FIG. 7, depicted therein is a method 700 of displaying visualizations on a display. The method starts in step 710 where data indicating a plurality informational items comprising at least one useful informational item is received at a processor. This data may be configured like the data contained in table 100 of FIG. 1, or like the data contained in table 220 of FIG. 2. In step 720 data indicating a plurality of questions comprising at least one unanswered question is also received at the processor. The data received in step 720 may be configured like the data contained in columns 112-116 of table 100 of FIG. 1, or the data contained in table 210 of FIG. 2.

In step 730, the processor analyzes a number of unanswered questions and a number of useful informational items. Step 730 may comprise analyzing a number of the plurality of questions which are not linked to at least one of the plurality of informational items. Because the processor knows the total number of questions, determining the number of unlinked questions may also comprise determining the number of linked questions. In fact, determining the number of unlinked questions may first comprise determining the number of linked questions, and using the difference between the total number of questions and the number of linked questions to determine the number of unlinked questions.

In step 740, the processor generates a visualization of the number useful informational items compared to the number of unanswered questions. Step 740 may comprise generating a visualization of the number of questions not linked to at least one informational item compared to both the total number of questions and the number of questions linked to at least one informational item. This visualization may take the form of one or more of visualizations 300a-c from FIG. 3.

Finally, in step 750, the visualization is displayed on a display.

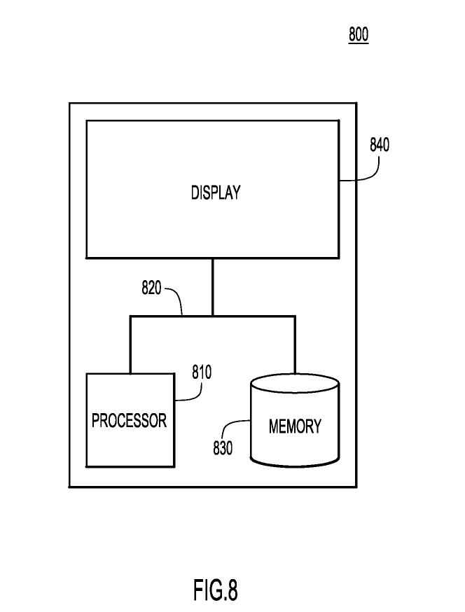

With reference now made to FIG. 8, depicted therein is an example block diagram of a device 800 configured to perform visualization display techniques described herein. The device comprises a processor 810, bus 820, memory 830, and display 840. The memory 830 comprises software instructions which when executed by the processor cause processor 810 to perform the display techniques described herein. Memory 830 may also store the question and informational item data utilized by the processor, though this data may also be stored externally of device 800.

Memory 830 may comprise read only memory (ROM), random access memory (RAM), magnetic disk storage media devices, optical storage media devices, flash memory devices, electrical, optical, or other physical/tangible (e.g., non-transitory) memory storage devices. The processor 810 is, for example, a microprocessor or microcontroller that executes instructions for the proxy device logic. Thus, in general, the memory 830 may comprise one or more tangible (non-transitory) computer readable storage media (e.g., a memory device) encoded with software comprising computer executable instructions and when the software is executed (by the processor 810), device 800 is operable to perform the operations described herein in connection with FIGS. 3-7.

The above description is intended by way of example only.

What is claimed is:

1. A method comprising:
receiving at a processor data indicating a plurality of informational items comprising at least one useful informational item;
receiving at the processor data indicating a plurality of questions comprising at least one unanswered question;
analyzing by the processor a number of unanswered questions and a number of useful informational items;
generating a visualization by the processor of the number useful informational items compared to the number of unanswered questions; and
displaying the visualization on a display.

2. The method of claim 1, wherein analyzing the number of useful informational items comprises determining a number of informational items that have received an indication of usefulness.

3. The method of claim 1, wherein the generating the visualization comprises:
generating a first area proportional to the total number useful informational items;
generating a second area proportional to the number of unanswered questions surrounding the first area.

4. The method of claim 3, wherein:
generating the first area comprises generating a first circular area;
generating the second area comprises generating an annular area surrounding the first circular area.

5. The method of claim 3, further comprising:
receiving a user selection of the first area; and
generating and displaying, in response to the selection of the first area, a plurality of second visual representations, wherein each of the second visual representations corresponds to one of the plurality of informational items, and a size of each of the second visual representations is proportional to the number of times the informational item has received an indication of usefulness.

6. The method of claim 5, wherein displaying the plurality of second visual representations comprises displaying the plurality of second visual representations within the first area.

7. The method of claim 5, wherein generating and displaying, in response to the selection of the first area, further comprises displaying a plurality of third visual representations, wherein each of the third visual representations corresponds to an informational item that has not received an indication of usefulness.

8. The method of claim 5, wherein receiving data indicating a plurality of informational items comprises receiving a first indication of usefulness and a second indication of usefulness for at least one informational item; and
wherein displaying the plurality of second visual representations comprises displaying an area of each second visual representation proportional to a value of the first indication of usefulness and displaying a width of a border of each second visual representation as proportional to a value of the second indication usefulness.

9. The method of claim 8, wherein receiving at least one of the first indication of usefulness and the second indication of usefulness comprises receiving the number of times the informational item has been linked to one of questions.

10. The method of claim 8, wherein receiving the first indication of usefulness comprises receiving at least one of a number of times the in informational item is indicated as answering one of the questions, a number of hypertext links to the informational item, a number of times the informational item was posted to a message board, or a number of times a user gives a positive review to the informational item.

11. The method of claim 10, wherein receiving the second indication of usefulness comprises receiving an indication of usefulness different from the first indication of usefulness, and receiving at least one of the number of times the informational item is indicated as answering one of the questions, the number of hypertext links to the informational item, the number of times the informational item was posted to the message board, or the number of times the user gives a positive review to the informational item.

12. The method of claim 1, further comprising:
receiving a user selection of the second area; and
generating and displaying, in response to the selection of the second area, a plurality of fourth visual representations, wherein each of the plurality of fourth visual representations corresponds to one of the plurality of questions.

13. The method of claim 12, wherein generating and displaying the plurality of fourth visual representations comprises displaying the plurality of fourth visual representations within the first area.

14. The method of claim 12, wherein generating and displaying the plurality of fourth visual representations comprises providing each fourth visual representation with a characteristic indicative of a subcategory of questions.

15. The method of claim 14, wherein providing each fourth visual representation with the characteristic indicative of the subcategory of questions comprises displaying each fourth visual representation with at least one of a color or a shape indicative of the sub-category of questions.

16. The method of claim 1, further comprising displaying a plurality of the visualizations wherein each visualization of the plurality comprises a visualization for a separate category of questions.

17. The method of claim 1, wherein receiving data indicating the plurality of questions comprises receiving questions received from at least one of messages posted to a message board or questions received at a call center.

18. The method of claim 1, wherein receiving data indicating the plurality of informational items comprises receiving data indicative of at least one of knowledge base entries, articles, technical documentation, or electronically accessible information.

19. The method of claim 1:
wherein receiving the plurality of informational items comprises receiving at least one informational item linked to at least one of the plurality of questions;
wherein at least one unanswered question comprises receiving at least one question not linked to at least one of the informational items;
wherein analyzing the number of unanswered questions and the number of useful informational items comprises analyzing a number of the plurality of questions which are not linked to at least one of the plurality of informational items;
wherein generating a visualization of the number useful informational items compared to the number of unanswered questions comprises generating a visualization of the number of the questions of the plurality of questions not linked to at least one of the plurality of informational items compared to a number of the plurality of questions which are linked to at least one of the plurality of informational items; and
wherein generating a visualization of the number useful informational items compared to the number of unanswered questions further comprises comparing the number of the questions of the plurality of questions not linked to at least one of the plurality of informational items and the number of the plurality of questions which are linked to at least one of the plurality of informational items to a total number of questions in the plurality of questions.

20. The method of claim 19, wherein the generating the visualization comprises:
generating a first area proportional to the total number of questions in the plurality of questions;
generating a second area proportional to the number of the plurality of questions which are linked to at least one of the plurality of informational items; and
overlapping the first area and the second area such that an overlapping area is proportional to a number of questions of the plurality of questions linked to at least one of the plurality of informational items and a non-overlapping area is proportional to the number of questions of the plurality of questions not linked to at least one of the plurality of informational items.

21. An apparatus comprising:
a memory storing data indicating a plurality of questions and data indicating a plurality of informational items, wherein each of the plurality of informational items is linked to at least one of the plurality of questions;
a display; and
a processor, wherein the processor is configured to:
receive data indicating a plurality of informational items comprising at least one useful informational item;
receive data indicating a plurality of questions comprising at least one unanswered question;
analyze a number of unanswered questions and a number of useful informational items;
generate a visualization of the number useful informational items compared to the number of unanswered questions; and
display the visualization on the display.

22. The apparatus of claim 21, wherein the processor is further configured to:
generate a first area proportional to the total number useful informational items;
generate a second area proportional to the number of unanswered questions surrounding the first area.

23. A non-transitory processor readable medium encoded with instructions that, when executed by a processor, cause the processor to:
receive data indicating a plurality of informational items comprising at least one useful informational item;
receive data indicating a plurality of questions comprising at least one unanswered question;
analyze a number of unanswered questions and a number of useful informational items;
generate a visualization of the number useful informational items compared to the number of unanswered questions; and
display the visualization on the display.

24. The processor readable medium of claim 23, wherein the instructions further cause the processor to:
generate a first area proportional to the total number useful informational items;
generate a second area proportional to the number of unanswered questions surrounding the first area.
